(19) United States
(12) Patent Application Publication
(10) Pub. No.: US 2018/0133658 A1
(43) Pub. Date: May 17, 2018

(54) ADSORPTIVE MEMBRANE

(71) Applicant: AMOGREENTECH CO., LTD., Gimpo-si (KR)

(72) Inventors: In Yong SEO, Seoul (KR); Ui Young JEONG, Incheon (KR)

(21) Appl. No.: 15/572,986

(22) PCT Filed: May 18, 2016
(86) PCT No.: PCT/KR2016/005255

§ 371 Date: Nov. 9, 2017

(30) Foreign Application Priority Data
Jun. 1, 2015 (KR) 10-2015-0077321

(51) Int. Cl. B01D 69/12; B01D 67/00; B01D 69/02

(52) U.S. Cl. CPC B01D 69/12; B01D 67/0093; B01D 69/02; B01D 2323/39; B01D 2325/48; B01D 2325/12; B01D 2325/14; B01D 2325/16; B01D 2325/42; B01D 2323/36

(57) ABSTRACT

Provided is an adsorptive membrane, which includes: a support member having a plurality of first pores; and a first adsorptive member which is stacked on the support member and has a plurality of second pores formed therein and which is made by accumulating ion exchange nanofibers for adsorbing foreign substances.

### TECHNICAL FIELD

The present disclosure relates to an adsorptive membrane, and more particularly to an adsorptive membrane capable of adsorbing ionic foreign substances by an adsorptive member made by accumulating ion exchange nanofibers, and capable of enabling physical adsorption of foreign substances by pores, thereby improving adsorption efficiency, and obtaining a desired antibacterial property.

### BACKGROUND ART

In recent years, industrial developments have caused various environmental problems due to pollutants caused by rapid economic growth, population growth and urbanization.

That is, pollutants such as wastewater, heavy metals, dust and harmful gas are discharged from manufacturing plants and industrial facilities of various industries, living facilities, automobiles and motorcycles, thereby polluting air and water quality.

These pollutants are interfering with the life of human being, who wants to live pleasant and healthy life, and various solutions to purify the pollutants have been sought, and the research and development for this have been continuously and variously continued.

An example technique for purifying contaminants is to filter the contaminated gas or liquid through a membrane.

Membranes can separate and filter only certain components from gases, liquids, solids or mixtures thereof, and the mixture is filtered using the physicochemical properties of the membrane.

Membranes in a water treatment field are classified into porous membranes, microporous membranes and homogeneous membranes depending on the structure of the membrane, and they are classified into microfiltration membranes, ultrafiltration membranes, reverse osmosis membranes, gas separation membranes, and pervaporation membranes depending on their applications.

Here, a polymer membrane is prepared by casting a polymer solution into a sheet and then immersing it in a solid phase. The polymer membranes have been used as a wide range of membranes ranging from microfiltration to gas permeation.

Korean Patent Application Publication No. 2011-85096 proposed a composite filter in which activated carbon fibers and ion exchange fibers are laminated on a side wall of a housing. However, there was a disadvantage that the size of the filter is large in the form of a composite filter.

Korean Patent Registration Publication No. 507969 proposed a technique of producing a web by forming a web of ion exchange fiber on an ion exchange nonwoven fabric, sprinkling ion exchange resin on the web, placing an ion exchange nonwoven fabric thereon, and removing ionic gas such as acidic or alkaline present in a clean room of a semiconductor manufacturing process, with a non-woven type composite ion exchange filter using needle punching. However, since the pores of the nonwoven fabric are large, the very fine harmful dust cannot be filtered, and the ion exchange resin sprayed on the ion exchange nonwoven fabric may flow to thereby cause an additional source of pollution to occur.

### DISCLOSURE

### Technical Problem

The present disclosure has been made in view of the above circumstances and has an object to provide an adsorptive membrane capable of adsorbing ionic foreign substances and physically filtering foreign substances by pores to improve the adsorption performance while preserving the flow rate.

It is another object of the present disclosure to provide an adsorptive membrane capable of obtaining an excellent antibacterial property by including an adsorptive member made by accumulating nanofibers containing an antibacterial substance or by performing a silver yarn stitching process on a membrane.

### Technical Solution

According to an aspect of the present disclosure, there is provided an adsorptive membrane comprising: a support member having a plurality of first pores; and a first adsorptive member which is stacked on the support member and has a plurality of second pores formed therein and which is made by accumulating ion exchange nanofibers for adsorbing foreign substances.

In addition, in the adsorptive membrane according to an embodiment of the present disclosure, the support member may be a nonwoven fabric or a woven fabric.

In addition, in the adsorptive membrane according to an embodiment of the present disclosure, the first pore size may be larger than the second pore size.

In addition, in the adsorptive membrane according to an embodiment of the present disclosure, the ion exchange nanofibers may be cation exchange nanofibers or anion exchange nanofibers.

In addition, in the adsorptive membrane according to an embodiment of the present disclosure, the first adsorptive member is laminated on an upper surface of the support member, and the adsorptive membrane may further comprise a second adsorptive member which is stacked on a lower surface of the support member and has a plurality of third pores formed therein, and which is made by accumulating ion exchange nanofibers for adsorbing foreign substances.

In addition, in the adsorptive membrane according to an embodiment of the present disclosure, the ion exchange nanofibers may be cation exchange nanofibers or anion exchange nanofibers, and the adsorptive membrane may further include a third adsorptive member which is stacked on the first adsorptive member and has a plurality of third pores formed therein, and which is made by accumulating other ion exchange nanofibers that exchange ions of opposite polarity with those of the ion exchange nanofibers for the first adsorptive member.

In addition, the adsorptive membrane according to an embodiment of the present disclosure may further comprise a nanofiber web that is laminated on the first adsorptive member and has a plurality of pores formed therein and that is made by accumulating nanofibers containing dopamine, to which functional groups for adsorbing foreign substances are attached.

Here, the nanofiber web may have the functional groups attached to the dopamine by a UV irradiation, a plasma treatment, an acid treatment, or a base treatment on a web prepared by electrospinning a spinning solution formed by mixing the dopamine with a solvent and a polymer substance. Here, each of the functional groups may be a negative charge functional group or a positive charge functional group.

In addition, in the adsorptive membrane according to an embodiment of the present disclosure, the ion exchange nanofibers may be coated with oil.

In addition, in the adsorptive membrane according to an embodiment of the present disclosure, the first adsorptive member may be designed to be thinner than the support member.

In addition, in the adsorptive membrane according to an embodiment of the present disclosure, one or both of the support member and the first adsorptive member may further comprise stitched silver yarn.

According to another aspect of the present disclosure, there is provided an adsorptive membrane comprising: a support member having a plurality of first pores; a first adsorptive member stacked on an upper surface of the support member and having a plurality of second pores formed therein and made by accumulating ion exchange nanofibers for adsorbing foreign substances; and a second adsorptive member stacked on an upper surface of the first adsorptive member and having a plurality of second pores formed therein and made by accumulating nanofibers containing an antibacterial substance.

Here, the second and third pore sizes may be smaller than the first pore size, and the antibacterial substance may be a silver nanomaterial, and the second adsorptive member may have a nanofiber web structure formed by electrospinning a spinning solution prepared by dissolving the silver nanomaterial in an organic solvent together with a fiber formability polymer material.

### Advantageous Effects

According to some embodiments of the present disclosure, there are advantages that it is possible to adsorb ionic foreign substances by the ion exchange nanofibers of the adsorptive member and to physically filter the foreign substances having a size larger than the pore sizes of the pores of the support member and the pores of the adsorptive member to improve the adsorption efficiency of the foreign substances.

According to some embodiments of the present disclosure, the adsorptive member having the plurality of pores formed by the nanofibers is laminated on the support member having the plurality of pores to realize a membrane, thereby making it possible to improve the adsorption performance while preserving the passing flow rate.

According to some embodiments of the present disclosure, it is possible to realize an adsorptive member capable of being manufactured at low cost with excellent handling properties and strength by laminating the adsorption member and the support member.

According to some embodiments of the present disclosure, there are advantages that heavy metals, bacteria, or viruses contained in a passing gas or liquid may be adsorbed by nanofiber webs that are formed by accumulating nanofibers containing dopamine to which a functional group is attached, in which the nanofiber webs are included in the membrane.

According to some embodiments of the present disclosure, the membrane contains the adsorptive member formed by accumulating nanofibers containing a large number of pores and antibacterial substances, or the membrane undergoes a silver yarn stitching process, to thus improve an antibacterial property.

According to some embodiments of the present disclosure, it is possible to provide a membrane capable of adsorbing ionic foreign substances such as heavy metals and harmful minute substances such as dirt, dust, pieces, particles and the like, thereby being applicable to various fields such as water treatment, air filtration, bio-applications, medical applications, and the like.

### BRIEF DESCRIPTION OF THE DRAWINGS

FIG. 1 is a cross-sectional view of an adsorptive membrane according to a first embodiment of the present disclosure.

FIG. 2 is a schematic view illustrating the principle of adsorbing foreign substances on an adsorptive member according to an embodiment of the present disclosure.

FIG. 3 is a view schematically showing a state in which ion exchange nanofibers are accumulated by electrospinning a spinning solution to a support member according to an embodiment of the present disclosure.

FIG. 4 is a cross-sectional view of an adsorptive membrane according to a second embodiment of the present disclosure.

FIG. 5 is a cross-sectional view of an adsorptive membrane according to a third embodiment of the present disclosure.

FIG. 6 is a cross-sectional view of an adsorptive membrane according to a fourth embodiment of the present disclosure.

FIG. 7 is a cross-sectional view of an adsorptive membrane according to a fifth embodiment of the present disclosure.

FIG. 8 is a schematic plan view for explaining a state in which a silver yarn stitching process is applied on an adsorptive membrane according to an embodiment of the present disclosure.

### BEST MODE

Hereinafter, embodiments of the present disclosure will be described in detail with reference to the accompanying drawings.

Referring to FIG. 1, the adsorptive membrane 100 according to a first embodiment of the present disclosure includes: a support member 110 having a plurality of first pores; and an adsorptive member 120 which is stacked on the support member 110 and has a plurality of second pores formed therein, and which is made by accumulating ion exchange nanofibers for adsorbing foreign substances.

The adsorptive membrane 100 absorbs and filters ionic foreign substances by the ion exchange nanofibers of the adsorption member 120 and physically filters the foreign substances (for example, dirt, dust, debris, particles, etc.) having a size larger than the pore size by the first pores of the support member 110 and the second pores of the adsorptive member 120, to thus enhance the removal efficiency of the foreign substances.

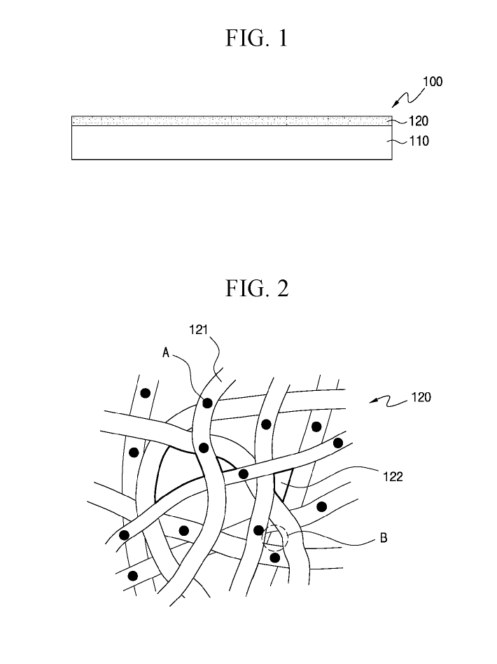

In other words, as shown in FIG. 2, when the gas or liquid passes through the adsorptive membrane 100, the ionic foreign substances A contained in the gas or liquid are adsorbed by the ion exchange nanofibers 121 of the adsorptive member 120, and the large-size foreign substances B included in the gas or liquid do not pass through the second pores 122 of the adsorptive member 120 and are trapped inside the adsorptive member 120. As a result, the foreign substances A and B are restrained in the adsorption state (the state that the foreign substances cannot escape from but stick to the inside of the adsorptive member 120) in the adsorptive membrane 100, and thus the filtering performance of the adsorptive membrane 100 according to some embodiments of the present disclosure may be increased.

Here, the second pores 122 of the adsorptive member 120 may filter nano-scale fine contaminants contained in the gas or liquid as micropores. That is, the adsorptive member 120 made of nanofibers performs adsorption by surface filtration on the surface layer and by deep filtration on the inner layer.

Therefore, the adsorptive membrane according to some embodiments of the present disclosure is not a non-porous membrane structure but is formed by laminating an adsorptive member having a plurality of pores made of nanofibers on a support member having a plurality of pores, to thus have advantages that the adsorption performance can be improved while preserving the passing flow rate.

Also, in some embodiments of the present disclosure, the large-size foreign substances B contained in the gas or liquid cannot pass through even the first pores of the support member 110, but are trapped inside the adsorptive membrane 100, so that the adsorption ability can be further improved. Here, the first pore size of the support member 110 is preferably larger than the second pore size 122 of the adsorptive member 120.

The support member 110 serves as a passageway for passing the gas or liquid through the plurality of first pores and serves as a support layer for supporting the adsorptive member 120 to maintain the flat plate shape. Here, the support member 110 is preferably a nonwoven fabric or a woven fabric.

The usable nonwoven fabric may be any one of a melt-blown nonwoven fabric, a spun bond nonwoven fabric, a thermal bond nonwoven fabric, a chemical bond nonwoven fabric, and a wet-laid nonwoven fabric. The fiber diameter of the nonwoven fabric may be 40 μm to 50 μm, and the pore size thereof may be 100 μm or more.

In addition, in some embodiments of the present disclosure, since the adsorptive member 120 made by accumulating ion exchange nanofibers has poor handleability and strength, the adsorptive member 120 and the support member 110 are laminated to thereby implement an adsorptive membrane having excellent handleability and strength.

Meanwhile, since the adsorptive member 120 made by accumulating the ion exchange nanofibers is expensive, implementing of the adsorptive membrane 100 in some embodiments of the present disclosure only by using the sole adsorptive member 120, requires a lot of manufacturing cost. Therefore, in some embodiments of the present disclosure, it is possible to reduce the manufacturing cost by stacking the supporting member, which is much cheaper than the adsorptive member 120 made by accumulating the ion exchange nanofibers, on the adsorptive member 120. In this case, the expensive adsorptive member 120 is designed to be thin and the low-priced support member 110 is designed to be thick, so that the manufacturing cost can be optimized at low cost.

In some embodiments of the present disclosure, an ion exchange solution is electrospun to discharge ion exchange nanofibers to the support member, and the discharged ion exchange nanofibers are accumulated in the support member 110 to produce the adsorptive member 120.

The ion exchange solution can be defined as a solution synthesized by a synthesis process such as bulk polymerization of a polymer, a solvent and ion exchange functional groups.

Since the ion exchange functional groups are contained in the ion exchange nanofibers, ionic foreign substances such as heavy metals contained in the gas or liquid passing through the adsorptive membrane 100 are exchanged by substitution and adsorbed to the ion exchange functional groups. As a result, the ionic foreign substances are adsorbed to the ion exchange nanofibers by the ion exchange functional groups.

For example, when the ion exchange functional groups are SO3H, and/or NH4CH3, the ionic foreign substances (for example, ionic heavy metal positive ions or heavy metal negative ions) contained in water are replaced with H+ and/or CH3+ by substitution, and adsorbed to the ion exchange functional groups.

Here, the ion exchange functional groups include a cation exchange functional group selected from a sulfonic acid group, a phosphoric acid group, a phosphonic group, a phosphonic group, a carboxylic acid group, an arsonic group, a selenonic group, an iminodiacetic acid group and a phosphoric acid ester group; or an anion exchange functional group selected from a quaternary ammonium group, a tertiary amino group, a primary amino group, an imine group, a tertiary sulfonium group, a phosphonium group, a pyridyl group, a carbazolyl group and an imidazolyl group.

Here, the polymer is a resin that is capable of being electrospun, capable of being dissolved in an organic solvent for electrospinning, and capable of forming nanofibers by electrospinning, but is not particularly limited thereto. For example, the polymer may include: polyvinylidene fluoride (PVdF), poly (vinylidene fluoride-co-hexafluoropropylene), perfluoropolymers, polyvinyl chloride, polyvinylidene chloride, or co-polymers thereof; polyethylene glycol derivatives containing polyethylene glycol dialkylether and polyethylene glycol dialkyl ester; polyoxide containing poly (oxymethylene-oligo-oxyethylene), polyethylene oxide and polypropylene oxide; polyacrylonitrile co-polymers containing polyvinyl acetate, poly (vinyl pyrrolidone-vinyl acetate), polystyrene and polystyrene acrylonitrile co-polymers, polyacrylonitrile (PAN), or polyacrylonitrile methyl methacrylate co-polymers; or polymethyl methacrylate and polymethyl methacrylate co-polymers, or a mixture thereof.

In addition, examples of the usable polymer may include: aromatic polyester such as polyamide, polyimide, polyamide-imide, poly (meta-phenylene iso-phthalamide), polysulfone, polyether ketone, polyethylene terephthalate, polytrimethylene terephthalate, and polyethylene naphthalate; polyphosphazenes such as polytetrafluoroethylene, polydiphenoxy phosphazene, and poly {bis [2-(2-methoxyethoxy) phosphazene]}; polyurethane co-polymers including polyurethane and polyether urethane; cellulose acetate, cellulose acetate butylrate, cellulose acetate propionate, and the like.

As the polymer preferable for the adsorptive member, PAN, polyvinylidene fluoride (PVdF), polyester sulfone (PES) and polystyrene (PS) may be used alone or a mixture of polyvinylidene fluoride (PVdF) and polyacrylonitrile (PAN), or a mixture of PVDF and PES, and a mixture of PVdF and thermoplastic polyurethane (TPU) may be used.

As the solvent, a mono-component solvent such as dimethyl form amide (DMF) can be used. However, when a two-component solvent is used, it is preferable to use a two-component solvent in which a high boiling point (BP) solvent and a low boiling point (BP) solvent are mixed with each other.

As described above, a plurality of ultrafine pores (i.e., second pores) are formed between the ion exchange nanofibers that are accumulated randomly in the adsorptive member 120 which is formed by accumulating the ion exchange nanofibers in the support member 110. The ultrafine pore size is preferably 3 μm or less.

The diameter of each of the ion exchange nanofibers is preferably in the range of 0.1 μm to 3.0 μm, and the thickness of the adsorptive member 120 is freely adjusted according to a spinning time from an electrospinning apparatus. The pore size is determined according to the thickness of the adsorptive member 120.

The ion exchange nanofibers can be defined as having ion exchange functional groups having ion exchange ability on the surface thereof. Depending on the ions exchanged in the ion exchange functional groups, the ion exchange nanofibers can be cation exchange nanofibers or anion exchange nanofibers.

The adsorptive member 120 formed by accumulating the ion exchange nanofibers is a web structure of ion exchange nanofibers. The web is ultra-thin, ultra-light in weight, and large in specific surface area.

In some embodiments of the present disclosure, the ion exchange nanofibers are accumulated in the support member 110 by electrospinning the ion exchange nanofibers to form the adsorptive member 120, thereby increasing a coupling force between the support member 110 and the absorptive member 120. Accordingly, there is an advantage that the adsorptive member 120 can be prevented from being peeled off from the support member 110 by external force.

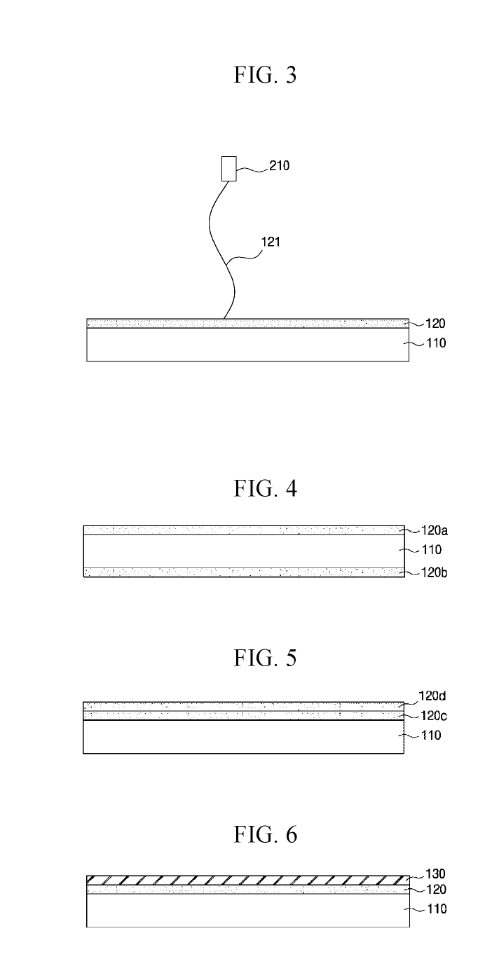

In other words, as shown in FIG. 3, the ion exchange nanofibers 121 discharged from a spinning nozzle 210 of the electrospinning apparatus are stacked on the supporting member 110, and the stacked ion exchange nanofibers 121 are accumulated, and thus a web-shaped adsorptive member 120 is formed.

FIGS. 4 to 7 are cross-sectional views of the adsorptive membrane according to the second to fifth embodiments of the present disclosure.

Referring to FIG. 4, an adsorptive membrane according to the second embodiment of the present disclosure includes: a support member 110 having a plurality of first pores; a first adsorptive member 120a stacked on an upper surface of the support member 110 and having a plurality of second pores formed therein and made by accumulating ion exchange nanofibers for adsorbing foreign substances; and a second adsorptive member 120b stacked on a lower surface of the support member 110 and having a plurality of third pores formed therein and made by accumulating ion exchange nanofibers for adsorbing foreign substances.

The adsorptive membrane according to the second embodiment is configured to include first and second adsorptive members 120a and 120b that are laminated on both sides of the support member 110 to adsorb the ionic foreign substances not adsorbed by the first adsorption member 120a, and foreign substances having pore sizes larger than the pore sizes of the third pores by the second adsorptive member 120b, thereby increasing the adsorption efficiency of foreign substances.

Here, the first pore size may be designed to be the largest, the second pore size may be designed to have an intermediate size between the first pore size and the third pore size, and the third pore size may be designed to be the smallest.

Referring to FIG. 5, an adsorptive membrane according to the third embodiment of the present disclosure includes: a support member 110 having a plurality of first pores; a first adsorptive member 120c stacked on an upper surface of the support member 110 and having a plurality of second pores formed therein and made by accumulating first ion exchange nanofibers for adsorbing foreign substances; and a second adsorptive member 120d stacked on an upper surface of the first adsorptive member 120c and having a plurality of third pores formed therein and made by accumulating second ion exchange nanofibers for adsorbing foreign substances.

The first ion exchange nanofibers of the first adsorptive member 120c may be cation exchange nanofibers or anion exchange nanofibers, and the second ion exchange nanofibers of the second adsorptive member 120d may be nanofibers that exchange ions of opposite polarity to the first ion exchange nanofibers. That is, when the first ion exchange nanofibers are cation exchange nanofibers, the second ion exchange nanofibers are anion exchange nanofibers.

Therefore, the adsorptive membrane according to the third embodiment is advantageous in that both the first heavy metal and the cation heavy metal and anion heavy metal contained in the passing gas or liquid can be adsorbed by the first and second adsorptive members 120c and 120d.

Referring to FIG. 6, an adsorptive membrane according to the fourth embodiment of the present disclosure includes: a support member 110 having a plurality of first pores; a first adsorptive member 120 stacked on an upper surface of the support member 110 and having a plurality of second pores formed therein and made by accumulating ion exchange nanofibers for adsorbing foreign substances; and a second adsorptive member 130 stacked on an upper surface of the first adsorptive member 120 and having a plurality of third pores formed therein and made by accumulating nanofibers containing an antibacterial substance.

The adsorptive membrane applied in the gas filter according to the fourth embodiment can adsorb ionic foreign substances by the ion exchange nanofibers of the first adsorptive member 120 and can have the antibacterial property by the nanofibers containing the antibacterial substance of the second adsorptive member 130.

Here, the second and third pore sizes are preferably designed to be smaller than the first pore size.

The adsorptive membrane can also physically filter and adsorb foreign substances having a size larger than the pore size in each of the first to third pores.

Here, the antibacterial substances are preferably silver nano materials. Here, the silver nano materials are silver (Ag) salts such as silver nitrate (AgNO3), silver sulfate (Ag2SO4), and silver chloride (AgCl).

In some embodiments of the present disclosure, a silver nanomaterial is dissolved in an organic solvent together with a fiber formability polymer material to prepare a spinning solution, and the spinning solution is electrospun to obtain a second adsorptive member 130 of a nanofiber web structure formed by accumulating nanofibers containing an antibacterial substance.

In the adsorptive membrane according to the fifth embodiment of the present disclosure may further include a nanofiber web, which has a plurality of pores, and which is made by accumulating nanofibers containing dopamine having a functional group for adsorbing foreign substances, in addition to the adsorptive membrane according to each of the previous embodiments. Here, the nanofiber web containing dopamine is preferably laminated on the adsorptive member.

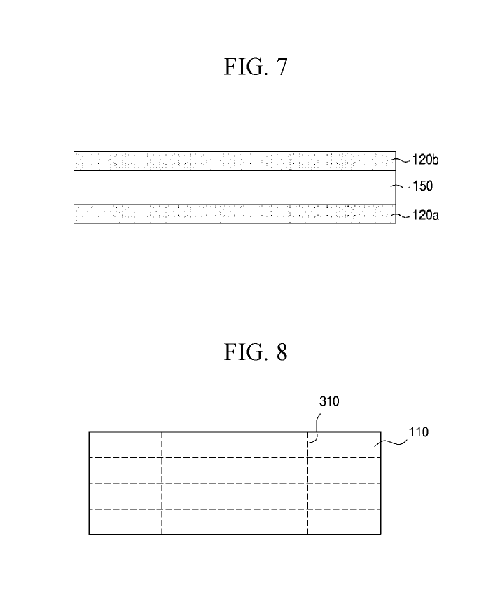

For example, as shown in FIG. 7, the adsorptive membrane may be implemented by interposing a nanofiber web 150 between the first and second adsorptive members 120a and 120b, in which the nanofiber web 150 is made by accumulating nanofibers having a plurality of pores formed and containing dopamine, to which a functional group capable of adsorbing foreign substances is attached.

Here, the first and second adsorptive members 120a and 120b are adsorptive members formed by accumulating ion exchange nanofibers having a plurality of pores and adsorbing foreign substances, and the nanofiber web 150 is produced by electrospinning a spinning solution which is made by mixing a dopamine monomer or polymer, a solvent and a polymer substance.

Dopamine (i.e. 3, 4-dihydroxyphenylalamine) has a structure in which —NH2 and —OH are bonded to a benzene ring.

The functional groups attached to the dopamine contained in the nanofibers can be formed by a post-treatment such as UV irradiation, plasma treatment, acid treatment, and base treatment after forming a nanofiber web containing a dopamine monomer or polymer. Finally, the nanofiber web containing dopamine is in a state where the functional group is attached to the nanofiber.

Here, the functional group can function as a negative charge functional group such as SO3H— or a positive charge functional group such as NH4+ to adsorb heavy metals, bacteria and viruses. Thus, the adsorptive membrane according to the fifth embodiment of the present disclosure can filter heavy metals, bacteria and viruses contained in the passing gas or liquid and adsorb the filtered heavy metals, bacteria and viruses inside the adsorptive membrane.

FIG. 8 is a schematic plan view for explaining a state in which a silver yarn stitching process is applied on an adsorptive membrane according to an embodiment of the present disclosure.

According to the embodiments of the present disclosure, the adsorptive membrane including the support member can be subjected to a silver yarn stitching process to realize an adsorptive membrane having antibacterial properties by the stitched silver yarn. Here, the silver yarn stitching process may be performed on one or both of the support member and the adsorptive member of the adsorptive membrane.

Here, since the adsorptive member of the adsorptive membrane has a relatively lower strength than the support member, if the silver yarn is stitched to the adsorptive member, damage to the adsorptive member may be caused by the stitched silver yarn.

Meanwhile, the support member has a strength enough to withstand the silver yarn stitching process, thereby stitching the silver yarn 310 on the support member 110, as shown in FIG. 12. In this case, it is preferable that the silver yarn 310 is stitched in a lattice pattern, but it is not limited thereto.

The silver yarn is a thread made of silver. The silver yarn stitched to the support member 110 can kill the bacteria contained in the passing gas or liquid, and the adsorptive membrane can have a strong antibacterial property.

Meanwhile, in some embodiments of the present disclosure, the nanofibers of the adsorptive member of the adsorptive membrane of the above-described embodiments may be coated with oil such as glycerin.

Since the adsorptive member has a web shape in which ion exchange nanofibers are accumulated, the nanofibers are coated with oil in order to activate adsorption of ion exchange functional groups present on the surfaces of ion exchange nanofibers, to thereby adsorb ionic foreign substances by the oil, and then by the exchange functional groups.

While the present invention has been particularly shown and described with reference to exemplary embodiments thereof, by way of illustration and example only, it is clearly understood that the present invention is not to be construed as limiting the present invention, and various changes and modifications may be made by those skilled in the art within the protective scope of the invention without departing off the spirit of the present invention.

### INDUSTRIAL APPLICABILITY

The present disclosure can be applied to an adsorptive membrane capable of adsorbing ionic foreign substances by an adsorbent member in which ion exchange nanofibers are accumulated, physically adsorbing by pores, thereby improving adsorption efficiency and obtaining excellent antibacterial properties.

What is claimed is:

1. An adsorptive membrane comprising:
a support member having a plurality of first pores; and
a first adsorptive member which is stacked on the support member and has a plurality of second pores formed therein and which is made by accumulating ion exchange nanofibers for adsorbing foreign substances.

2. The adsorptive membrane of claim 1, wherein the support member is a nonwoven fabric or a woven fabric.

3. The adsorptive membrane of claim 1, wherein the first pore size may be larger than the second pore size.

4. The adsorptive membrane of claim 1, wherein the ion exchange nanofibers are cation exchange nanofibers or anion exchange nanofibers.

5. The adsorptive membrane of claim 1, wherein the first adsorptive member is laminated on an upper surface of the support member, and the adsorptive membrane further comprises a second adsorptive member which is stacked on a lower surface of the support member and has a plurality of third pores formed therein, and which is made by accumulating ion exchange nanofibers for adsorbing foreign substances.

6. The adsorptive membrane of claim 1, wherein the ion exchange nanofibers are cation exchange nanofibers or anion exchange nanofibers, and the adsorptive membrane further comprises a second adsorptive member which is stacked on the first adsorptive member and has a plurality of third pores formed, and which is made by accumulating other ion exchange nanofibers that exchange ions of opposite polarity with those of the ion exchange nanofibers for the first adsorptive member.

7. The adsorptive membrane of claim 1, further comprising a nanofiber web, which is stacked on the first adsorptive member and has a plurality of pores, and which is made by accumulating nanofibers containing dopamine having functional groups for adsorbing foreign substances.

8. The adsorptive membrane of claim 7, wherein the nanofiber web has the functional groups attached to the dopamine by a UV irradiation, a plasma treatment, an acid treatment, or a base treatment on a web prepared by electrospinning a spinning solution formed by mixing the dopamine with a solvent and a polymer substance.

9. The adsorptive membrane of claim 7, wherein each of the functional groups is a negative charge functional group or a positive charge functional group.

10. The adsorptive membrane of claim 1, wherein the first adsorptive member may be designed to be thinner than the support member.

11. The adsorptive membrane of claim 1, wherein one or both of the support member and the first adsorptive member further comprises stitched silver yarn.

12. The adsorption membrane of claim 1, wherein the ion exchange nanofibers are coated with oil.

13. An adsorptive membrane comprising:
a support member having a plurality of first pores;
a first adsorptive member stacked on an upper surface of the support member and having a plurality of second pores formed therein and made by accumulating ion exchange nanofibers for adsorbing foreign substances; and
a second adsorptive member stacked on an upper surface of the first adsorptive member and having a plurality of second pores formed therein and made by accumulating nanofibers containing an antibacterial substance.

14. The adsorption membrane of claim 13, wherein the second and third pore sizes are smaller than the first pore size.

15. The adsorption membrane of claim 13, wherein the antibacterial substance is a silver nanomaterial.

16. The adsorption membrane of claim 15, wherein the second adsorptive member has a nanofiber web structure formed by electrospinning a spinning solution prepared by dissolving the silver nanomaterial in an organic solvent together with a fiber formability polymer material.
